(19) United States
(12) Patent Application Publication
(10) Pub. No.: US 2020/0029140 A1
(43) Pub. Date: Jan. 23, 2020

(54) WEARABLE MICROPHONE

(71) Applicant: Champions Centre, Tacoma, WA (US)

(72) Inventor: Paul Burton, Tacoma, WA (US)

(73) Assignee: Champions Centre, Tacoma, WA (US)

(21) Appl. No.: 16/451,818

(22) Filed: Jun. 25, 2019

Related U.S. Application Data
(60) Provisional application No. 62/689,623, filed on Jun. 25, 2018.

(51) Int. Cl. H04R 1/02; G02C 11/00; H04R 1/08

(52) U.S. Cl. CPC H04R 1/028; H04R 1/08; G02C 11/10

(57) ABSTRACT

The current document is directed to a wearable microphone that is mounted to the frame of a pair of glasses. The microphone is less noticeable and less obtrusive than commonly used headset-mounted microphones and is more comfortable for many users.

### CROSS-REFERENCE TO RELATED APPLICATION

This application claims the benefit of Provisional Application No. 62/689,623, filed Jun. 25, 2018.

### TECHNICAL FIELD

The current document is directed to wearable microphones and, in particular, to a wearable microphone incorporated into a glasses frame to capture a user's speech for transmission to an amplification-and-broadcast system.

### BACKGROUND

Microphones connected to public-address (“PA”) equipment been used, for many years to amplify human speech to enable members of an audience to clearly hear what is set by a lecturer, presenter, singer, or other types of performer or entertainer. Initially, microphones were large, heavy metallic units typically affixed to heavy metal stands, with the microphone signal transmitted through wires or cable to the PA system. As technology advanced, lighter hand-held microphones became popular. Further technological advances provided cordless microphones with small transmitters for transmitting the audio signal captured by the microphone via radio-frequency signals to receivers directly coupled to PA systems. More recently, microphones have been miniaturized to the extent that they can be extended on thin, nonintrusive mounts from headsets. While current microphone technology provides much greater mobility and fewer constraints to microphone users, many lectures and presenters nonetheless find headset-mounted microphones annoying and constraining. In addition, although small and thin, the protruding microphone loads can be perceived as visually distracting and unnatural. For these reasons, lectures and presenters continue to seek better wearable microphones without the disadvantages of current headset-mounted miniature microphones.

### SUMMARY

The current document is directed to a wearable microphone that is mounted to the frame of a pair of glasses. The microphone is less noticeable and less obtrusive than commonly used headset-mounted microphones and is more comfortable for many users.

### BRIEF DESCRIPTION OF THE DRAWINGS

FIG. 1 shows the components used in of one implementation of the currently disclosed microphone-mounting system.

FIG. 2 shows several of the components shown in FIG. 1 assembled along the glasses frame.

FIG. 3 shows an alternative view of the component assembly shown in FIG. 2.

FIG. 4 shows the position of the microphone shield in the assembled microphone-mounting system.

### DETAILED DESCRIPTION

15

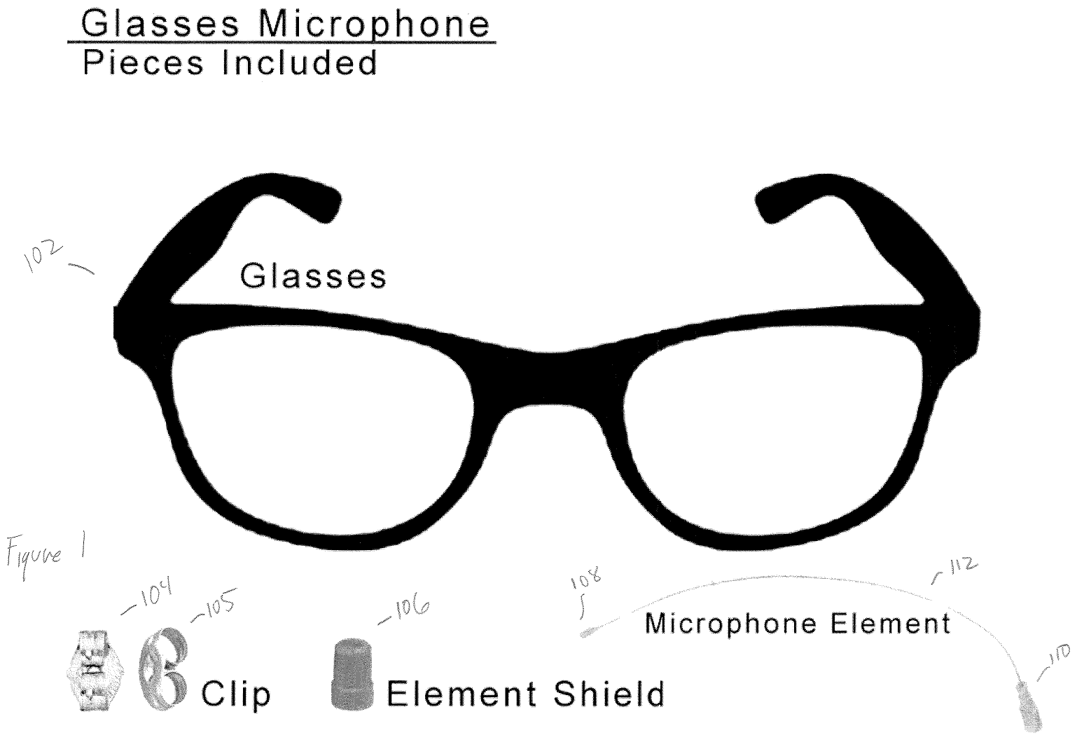

FIG. 1 shows the components used in of one implementation of the currently disclosed microphone-mounting system. These components include a glasses frame 102, two clips 104-105, an element shield 106, and a miniature microphone 108 coupled to a microphone connector 110 via an insulated signal-transmission wire 112. In one implementation, an H6 Countrymen miniature microphone is used. The microphone connector 110 is complementary to a cable connector that extends from a body pack that includes a power supply, such as a battery, and a transmitter/receiver.

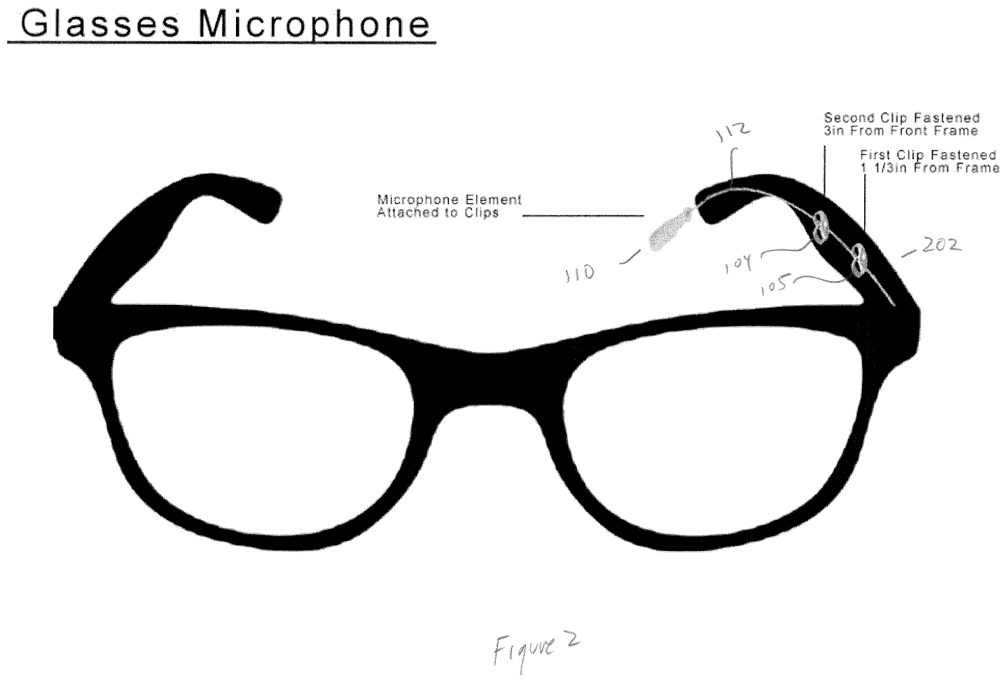

FIG. 2 shows several of the components shown in FIG. 1 assembled along the glasses frame. The microphone connector 110 can be seen trailing from the end of the left glasses-frame side member 202, with the insulated signal-transmission wire 112 running along the inner surface of the left glasses-frame side member through clips 104 and 105. In one implementation, the clips are held to the inner surface of the left glasses-frame side member by an adhesive. In alternative implementations, the clips may be mounted via one or more fasteners or a combination of one or more fasteners and adhesives.

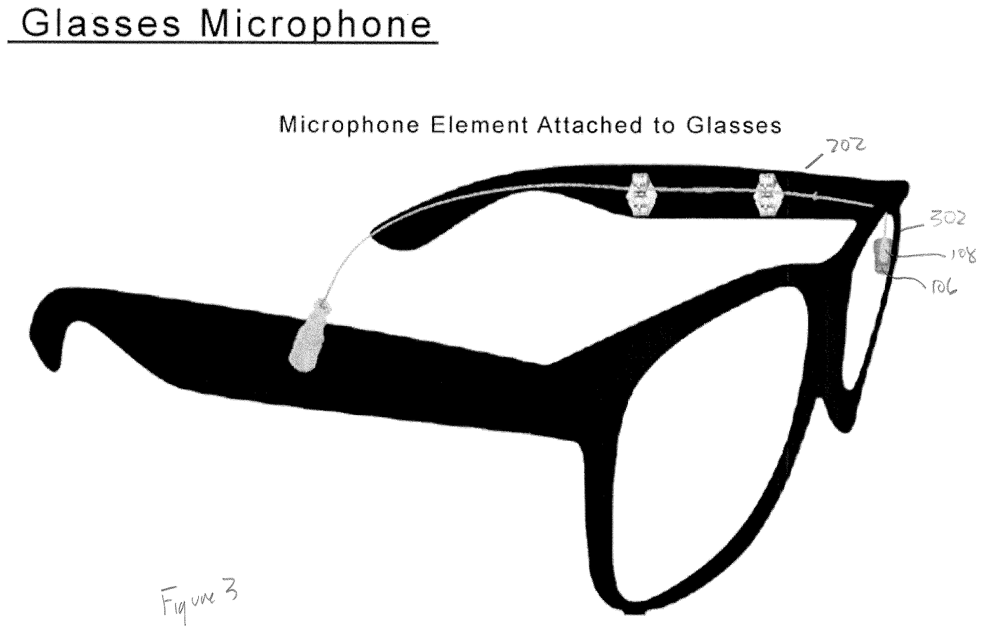

FIG. 3 shows an alternative view of the component assembly shown in FIG. 2. In FIG. 3, the element shield 106 is shown attached to the eye-wire member 302 of the glasses frame. The miniature microphone 108 is suspended from one or more features on the left glasses-frame side member 202 in order to reside within the element shield. In one implementation, the element shield is attached to the left eye-wire member of the glasses frame 302 by an adhesive. In alternative implementations, the element shield may be attached by one or more fasteners or a combination of one or more fasteners and adhesive. The element shield protects the miniature microphone from dust particles, sweat, and other environmental insults, maintains a position of the microphone, and, in certain cases, to contribute to the fidelity of voice capture by the microphone.

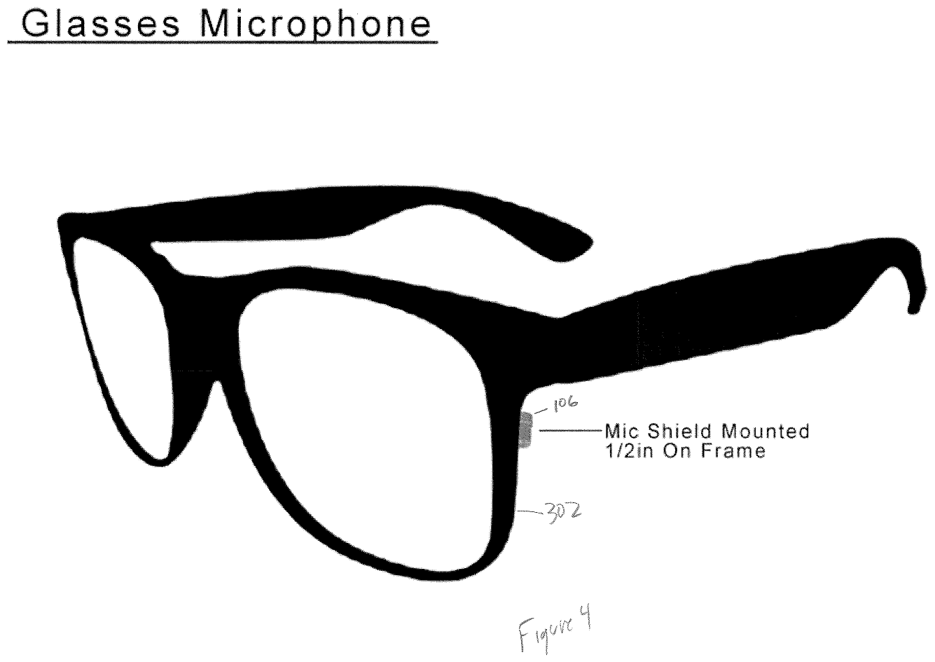

FIG. 4 shows the position of the microphone shield in the assembled microphone-mounting system. The element shield is clearly shown to be mounted to the left eye-wire member of the glasses frame 302.

Although the present invention has been described in terms of particular embodiments, it is not intended that the invention be limited to these embodiments. Modifications within the spirit of the invention will be apparent to those skilled in the art. For example, any of many different types of glasses may be used, with or without lenses. Many different miniature microphones may also be used. In alternative implementations, the miniature microphone may include a miniature transmitter that transmits radio-frequency signals directly to a body-pack receiver, is a result of which the insulated signal-transmission wire and electromechanical microphone connector are not needed. The various components may be mounted to either left-hand or right-hand frame members, in alternative embodiments.

It is appreciated that the previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

1. A wearable microphone and microphone-mounting system comprising:
a glasses frame;
an element shield mounted to the glasses frame;
a miniature microphone suspended within the element shield by a signal-transmission wire that is attached by one or more clips to the inner surface of a glasses-frame member and leads to a microphone connector suspended from the end of the glasses-frame member.
